(19) United States
(12) Patent Application Publication
(10) Pub. No.: US 2026/0233694 A1
(43) Pub. Date: Aug. 13, 2026

(54) COLLISION NOTIFICATION CIRCUIT AND CONTROL METHOD USING THE SAME

(71) Applicant: Robert Bosch GmbH, Stuttgart (DE)

(72) Inventors: Xiaofei Qiu, Suzhou (CN); David Voigt, Abstatt (DE)

(21) Appl. No.: 19/535,540

(22) Filed: Feb. 10, 2026

(30) Foreign Application Priority Data
Feb. 12, 2025 (CN) 2025 1015 8152.2

(51) Int. Cl. B60R 21/0136; B60L 3/04; B60R 21/01

(52) U.S. Cl. CPC B60R 21/0136; B60L 3/04; B60R 2021/01013

(57) ABSTRACT

A collision notification circuit includes (i) a collision notification resistor, wherein a voltage change across the collision notification resistor is used to indicate the occurrence of a collision event and potential fault modes of the collision notification circuit, (ii) a high-side power stage circuit coupled between a first power supply and the collision notification resistor and including a first switching transistor, wherein the first switching transistor is controlled by a first drive signal related to the collision event, and (iii) a low-side power stage circuit coupled between the collision notification resistor and ground and comprising a second switching transistor, wherein the second switching transistor is controlled by a second drive signal related to the collision event, wherein the first drive signal and the second drive signal are independent of each other. A control method utilizing a collision notification circuit and an electronic control unit is also disclosed.

This application claims priority under 35 U.S.C. § 119 to application no. CN 2025 1015 8152.2 filed on Feb. 12, 2025 in China, the disclosure of which is incorporated herein by reference in its entirety.

This application relates to the field of vehicle safety technology, and more particularly, to a collision notification circuit, a control method using the same, and an electronic control unit (ECU).

### BACKGROUND

With the development of vehicle electrification and intelligence, the safety performance of vehicles is receiving increasing attention. Rapidly cutting off the power supply upon vehicle collision to prevent electric shock accidents and further damage is an important measure to improve vehicle safety. For example, in new energy vehicles (NEVs), high-voltage batteries are used to power the entire vehicle. In the event of a collision, it is necessary to cut off the power supply from the high-voltage battery to protect the safety of the driver and passengers. This is because if the high-voltage battery is damaged and short-circuits, it can release a large amount of energy in a very short time. If the high-voltage battery is not disconnected promptly, it may quickly cause a fire.

Currently, in new energy vehicles, airbag systems are typically used to cut off the high-voltage battery during a collision event. However, this method is costly and difficult to repair. Moreover, existing collision detection and power cutoff systems suffer from issues such as slow response times and incomplete fault detection.

### SUMMARY

According to one aspect of the present application, a collision notification circuit is provided. The collision notification circuit comprises: a collision notification resistor, wherein a voltage change across the collision notification resistor is used to indicate the occurrence of a collision event and potential fault modes of the collision notification circuit; a high-side power stage circuit coupled between a first power supply and the collision notification resistor and comprising a first switching transistor, wherein the first switching transistor is controlled by a first drive signal related to the collision event; and a low-side power stage circuit coupled between the collision notification resistor and ground and comprising a second switching transistor, wherein the second switching transistor is controlled by a second drive signal related to the collision event, wherein the first drive signal and the second drive signal are independent of each other.

As a supplement or alternative to the above solution, in the collision notification circuit, under normal conditions, the first switching transistor and the second switching transistor are in an off state, and in the event of a collision, the first switching transistor and the second switching transistor remain in a conductive state under the control of the first drive signal and the second drive signal, respectively.

As a supplement or alternative to the above solution, the collision notification circuit further comprises: a collision event safety signal circuit configured to receive a collision trigger signal from an application-specific integrated circuit (ASIC) and adaptively output the first drive signal to turn on the first switching transistor.

As a supplement or alternative to the above solution, the collision notification circuit further comprises: a microcontroller algorithm control circuit for evaluating a collision event based on sensor input data using a collision detection algorithm in a microcontroller; and a watchdog fault-free signal circuit for indicating a monitoring result for the microcontroller, wherein the microcontroller algorithm control circuit and the watchdog fault-free signal circuit jointly provide the second drive signal, and output the second drive signal to turn on the second switching transistor when the microcontroller algorithm control circuit evaluates that a collision event exists and the watchdog fault-free signal circuit indicates that the microcontroller is fault-free.

As a supplement or alternative to the above solution, in the collision notification circuit, the high-side power stage circuit comprises: a first resistor, a first switching transistor, a second resistor, and a first capacitor, wherein one end of the first resistor is coupled to the first power supply, and the other end of the first resistor is coupled to the gate of the first switching transistor; the gate of the first switching transistor is coupled to the first drive signal, the source of the first switching transistor is coupled to the first power supply, and the drain of the first switching transistor is coupled to a first end of the collision notification resistor; one end of the second resistor is coupled to the first power supply, and the other end of the second resistor is coupled to the drain of the first switching transistor; one end of the first capacitor is coupled to the drain of the first switching transistor, and the other end of the first capacitor is grounded.

As a supplement or alternative to the above solution, in the collision notification circuit, the low-side power stage circuit comprises: a third resistor, a second switching transistor, a fourth resistor, and a second capacitor, wherein one end of the third resistor is coupled to the gate of the second switching transistor, and the other end of the third resistor is grounded; the gate of the second switching transistor is coupled to the second drive signal, the source of the second switching transistor is grounded, and the drain of the second switching transistor is coupled to a second end of the collision notification resistor; one end of the fourth resistor is grounded, and the other end of the fourth resistor is coupled to the drain of the second switching transistor; one end of the second capacitor is coupled to the drain of the second switching transistor, and the other end of the second capacitor is grounded.

As a supplement or alternative to the above solution, in the collision notification circuit, the first switching transistor is a PMOS transistor, and the second switching transistor is an NMOS transistor.

As a supplement or alternative to the above solution, in the collision notification circuit, the collision event safety signal circuit comprises: a fifth resistor, a sixth resistor, a third switching transistor, a seventh resistor, a first transistor, an eighth resistor, a ninth resistor, a tenth resistor, and a second transistor, wherein one end of the fifth resistor is coupled to the gate of the third switching transistor, and the other end of the fifth resistor is grounded; one end of the sixth resistor is coupled to a second power supply, and the other end of the sixth resistor is coupled to the drain of the third switching transistor; the gate of the third switching transistor is coupled to the collision trigger signal, and the source of the third switching transistor is grounded; one end of the seventh resistor is coupled to the second power supply, and the other end of the seventh resistor is coupled to the emitter of the first transistor; the base of the first transistor is coupled to the drain of the third switching transistor, the collector of the first transistor is coupled to one end of the eighth resistor, and the other end of the eighth resistor is grounded; one end of the ninth resistor is coupled to the collector of the first transistor, and the other end of the ninth resistor is coupled to the base of the second transistor; one end of the tenth resistor is coupled to the high-side power stage circuit to provide the first drive signal, the other end of the tenth resistor is coupled to the collector of the second transistor, and the emitter of the second transistor is grounded.

As a supplement or alternative to the above solution, in the collision notification circuit, the microcontroller algorithm control circuit comprises an eleventh resistor, and the watchdog fault-free signal circuit comprises a twelfth resistor and a fourth switching transistor, wherein one end of the eleventh resistor is coupled to a control signal from the microcontroller, and the other end of the eleventh resistor is coupled to the low-side power stage circuit; one end of the twelfth resistor is coupled to the gate of the fourth switching transistor, and the other end of the twelfth resistor is grounded; the drain of the fourth switching transistor is coupled to the low-side power stage circuit, the gate of the fourth switching transistor is coupled to a monitoring signal from a watchdog circuit, and the source of the fourth switching transistor is grounded.

As a supplement or alternative to the above solution, in the collision notification circuit, the potential fault modes of the collision notification circuit include: battery short circuit, ground short circuit, cross-coupling, resistance change of the collision notification resistor, open/short circuit of the high-side power stage circuit, and open/short circuit of the low-side power stage circuit.

According to another aspect of the present application, a control method using the aforementioned collision notification circuit is provided. The method comprises the following steps: confirming the occurrence of a collision event by monitoring voltage changes across the collision notification resistor in the collision notification circuit; and cutting off the power supply or performing other safety protection measures after confirming the collision event.

According to yet another aspect of the present application, an electronic control unit (ECU) is provided. The electronic control unit (ECU) is configured to execute the control method as described above.

The collision notification circuit according to the embodiments of the present application provides an efficient, reliable, and cost-effective safety protection measure. For example, other electronic control units (ECUs) can be configured to determine whether a collision event has occurred by monitoring voltage changes across the collision notification resistor, thereby timely switching related power supplies or performing other protective measures to protect the safety of the driver and passengers. Additionally, the collision notification circuit is also capable of detecting various potential fault modes, such as open circuits, short circuits to the battery, short circuits to ground, and cross-coupling, which helps improve the overall safety and reliability of new energy vehicles.

Compared to the method of using an airbag system to cut off the high-voltage battery, the collision notification circuit according to the embodiments of the present application is less costly and easier to repair. Furthermore, in one embodiment, the collision notification circuit uses a differential voltage to detect a collision event. This differential voltage can last for hundreds of milliseconds (e.g., by setting a suitably large capacitor in the circuit), providing higher robustness. This means that even under extreme conditions, such as brief signal loss, the collision notification circuit can reliably notify of a collision event.

### BRIEF DESCRIPTION OF THE DRAWINGS

The foregoing and other objectives and advantages of the present application will become more fully apparent from the following detailed description taken in conjunction with the accompanying drawings, in which identical or similar elements are denoted by the same reference numerals.

FIG. 1 illustrates a block diagram of a collision notification circuit according to one embodiment of the present application;

FIG. 2 illustrates a schematic diagram of the principle of power cutoff using differential voltage detection according to one embodiment of the present application;

FIG. 3 illustrates a schematic diagram of a specific circuit design of the collision notification circuit according to one embodiment of the present application; and

FIG. 4 illustrates a flowchart of a control method using the collision notification circuit according to one embodiment of the present application.

### DETAILED DESCRIPTION

Hereinafter, the collision notification circuit scheme according to various exemplary embodiments of the present application will be described in detail with reference to the accompanying drawings.

In the description of this specification, descriptions referring to terms such as “one embodiment,” “some embodiments,” “example,” “specific example,” or “some examples” mean that specific features, structures, materials, or characteristics described in connection with the embodiment or example are included in at least one embodiment or example of the embodiments of the present application. In this specification, the schematic representations of the aforementioned terms do not necessarily refer to the same embodiment or example. Moreover, the described specific features, structures, materials, or characteristics may be combined in any suitable manner in one or more embodiments or examples. Furthermore, the terms “first,” “second,” and “third” are used for descriptive purposes only and should not be construed as indicating or implying relative importance. Additionally, without mutual contradiction, those skilled in the art may combine and integrate the different embodiments or examples described in this specification and the features of different embodiments or examples.

FIG. 1 illustrates a block diagram 1000 of a collision notification circuit according to one embodiment of the present application. The collision notification circuit 1000 comprises: a collision notification resistor 110, a high-side power stage circuit 120, and a low-side power stage circuit 130, wherein a voltage change across the collision notification resistor 110 is used to indicate the occurrence of a collision event and potential fault modes of the collision notification circuit 1000; the high-side power stage circuit 120 is coupled between a first power supply and the collision notification resistor 110 and includes a first switching transistor, wherein the first switching transistor is controlled by a first drive signal related to the collision event; and the low-side power stage circuit 120 is coupled between the collision notification resistor 110 and ground and includes a second switching transistor, wherein the second switching transistor is controlled by a second drive signal related to the collision event, wherein the first drive signal and the second drive signal are independent of each other.

In the context of this application, the term “collision notification resistor” refers to a resistor used to indicate the occurrence of a collision event through voltage changes across its terminals. For example, other monitoring circuits (e.g., monitoring circuits in other ECUs) can identify a collision event by detecting voltage changes across this collision notification resistor.

Additionally, in the context of this application, the side of the collision notification resistor closer to the power supply is referred to as the “high side,” while the side closer to the ground line is referred to as the “low side.” For example, the high-side power stage circuit 120 is coupled between the first power supply and the collision notification resistor 110, while the low-side power stage circuit 120 is coupled between the collision notification resistor 110 and ground.

The high-side power stage circuit 120 includes a first switching transistor that controls the current flowing from the first power supply to the collision notification resistor 110. The first switching transistor is controlled by the first drive signal, which is related to the collision event. This means that when a collision event is detected, the first drive signal triggers the first switching transistor to turn on or off, thereby controlling the flow of power. The low-side power stage circuit 130 includes a second switching transistor that controls the current flowing from the collision notification resistor 110 to ground. The second switching transistor is controlled by the second drive signal, which is also related to the collision event. The triggering of the second drive signal causes the second switching transistor to turn on or off, further controlling the current flow.

The first drive signal and the second drive signal are independent of each other, meaning that the high-side and low-side power stage circuits can respond to different signals or at different times, providing a more flexible control strategy.

The design of the above collision notification circuit 1000 enables timely detection of collision events and potential faults by monitoring voltage changes across the resistor, thereby protecting the driver and passengers. Compared to traditional collision notification systems using airbag systems, this circuit is lower in cost and easier to maintain. Moreover, using voltage changes to notify of collision events improves the accuracy and reliability of detection.

In one or more embodiments, in the above collision notification circuit 1000, under normal conditions, the first switching transistor and the second switching transistor are in an off state, and in the event of a collision, the first switching transistor and the second switching transistor remain in a conductive state under the control of the first drive signal and the second drive signal, respectively. That is, under normal conditions (i.e., when no collision occurs), the first and second switching transistors are in an off state by default, while during a collision, the first and second switching transistors are turned on under the control of the first and second drive signals, respectively.

Although not shown in FIG. 1, the above collision notification circuit 1000 further comprises: a collision event safety signal circuit configured to receive a collision trigger signal from an application-specific integrated circuit (ASIC) and adaptively output the first drive signal to turn on the first switching transistor.

The main function of the collision event safety signal circuit is to receive a collision trigger signal from the vehicle's application-specific integrated circuit ASIC and generate the first drive signal accordingly to control the conductive state of the first switching transistor. The design of this circuit aims to ensure a rapid response upon detecting a collision event, thereby triggering the power cutoff mechanism.

For example, the collision event safety signal circuit continuously monitors signals from the ASIC. The ASIC may integrate collision sensors capable of immediately detecting and issuing a trigger signal when a vehicle collision occurs. Upon receiving the collision trigger signal, the collision event safety signal circuit adaptively processes the signal to ensure it is suitable for use as a signal to drive the first switching transistor. The processed signal is used as the first drive signal and sent to the first switching transistor in the high-side power stage circuit to turn it on. Since the ASIC is designed for rapid collision detection, the collision event safety signal circuit enables a quick response to collision events.

In one embodiment, the design of the collision notification circuit 1000 also considers the collaborative operation of the collision event safety signal circuit with other circuit components to achieve more comprehensive system monitoring and control. For example, the above collision notification circuit 1000 may further comprise: a microcontroller algorithm control circuit for evaluating a collision event based on sensor input data using a collision detection algorithm in a microcontroller; and a watchdog fault-free signal circuit for indicating a monitoring result for the microcontroller, wherein the microcontroller algorithm control circuit and the watchdog fault-free signal circuit jointly provide the second drive signal, and output the second drive signal to turn on the second switching transistor when the microcontroller algorithm control circuit evaluates that a collision event exists and the watchdog fault-free signal circuit indicates that the microcontroller is fault-free.

The microcontroller algorithm control circuit uses the microcontroller to analyze input data from various sensors, applying a built-in collision detection algorithm to assess whether a collision event has occurred. For example, the microcontroller continuously receives sensor data, such as from accelerometers, gyroscopes, etc., which provide information about the vehicle's motion state. When this data indicates a possible collision, the microcontroller runs the collision detection algorithm to determine whether the power cutoff mechanism needs to be triggered.

The watchdog fault-free signal circuit monitors the operating state of the microcontroller to ensure it functions properly. The microcontroller algorithm control circuit and the watchdog fault-free signal circuit work together to provide the second drive signal. This design ensures that the second drive signal is output only when the microcontroller correctly evaluates a collision event and is itself fault-free, thereby turning on the second switching transistor. The design of the above collision notification circuit 1000 can detect and respond to microcontroller faults, enhancing the system's fault tolerance.

Referring to FIG. 2, it illustrates a schematic diagram of implementing power cutoff using differential voltage detection according to one embodiment of the present application. As shown in FIG. 2, the collision notification circuit 2000 includes a power supply 215, a high-side power stage circuit 220, a collision notification resistor 225, and a low-side power stage circuit 230. In the collision notification circuit 2000 of FIG. 2, the current flow is from the power supply 215 through the high-side power stage circuit 220 to the collision notification resistor 225, and finally through the low-side power stage circuit 230 to ground.

As can also be seen from FIG. 2, the collision event safety signal 205 is provided to the high-side power stage circuit 220 via the high-side driver 210 to drive or control the high-side power stage circuit 220. Similarly, the microcontroller algorithm control signal 202 and the watchdog fault-free signal 204 are jointly provided to the low-side driver 208 to drive or control the low-side power stage circuit 230.

Continuing with reference to FIG. 2, a high-side voltage monitor 222 located in other electronic control units (ECUs) is used to monitor the high-side voltage/potential of the collision notification resistor 225 (i.e., the voltage or potential near the power supply 215 side), while a low-side voltage monitor 224 located in other electronic control units (ECUs) is used to monitor the low-side voltage/potential of the collision notification resistor 225 (i.e., the voltage or potential near the ground side). The high-side voltage monitor 222 and the low-side voltage monitor 224 work together to provide comprehensive monitoring of the voltage across the collision notification resistor 225. By comparing the changes in the high-side and low-side voltages, the nature of the collision event and the state of the circuit can be more accurately determined, thereby improving the accuracy and reliability of collision detection. Moreover, the high-side voltage monitor 222 and the low-side voltage monitor 224 can detect various fault modes of the collision notification circuit 2000, such as open circuits, short circuits, etc., enhancing the fault diagnosis capability of the entire system.

Referring to FIG. 3, it shows a schematic diagram of a specific circuit design of a collision notification circuit according to an embodiment of the present application. As shown in FIG. 3, the power supply module 310 includes a first power supply V1 and a second power supply V2, wherein the first power supply V1 is used to supply power to the high-side power stage circuit 340, and the second power supply V2 is used to supply power to the collision event safety signal circuit 315. The current flow direction in the entire circuit is from the first power supply V1 through the high-side power stage circuit 340 to the load 360, i.e., the collision notification resistor Rn, and finally through the low-side power stage circuit 350 to ground.

In the collision notification circuit of FIG. 3, the high-side power stage circuit 340 includes: a first resistor R1, a first switching transistor M1, a second resistor R2, and a first capacitor C1, wherein one end of the first resistor R1 is coupled to the first power supply V1 (positive terminal), and the other end of the first resistor R1 is coupled to the gate of the first switching transistor M1; the gate of the first switching transistor M1 is coupled to the output of the collision event safety signal circuit 315, the source of the first switching transistor M1 is coupled to the first power supply V1, and the drain of the first switching transistor M1 is coupled to a first end of the collision notification resistor Rn; one end of the second resistor R2 is coupled to the first power supply V1, and the other end of the second resistor R2 is coupled to the drain of the first switching transistor M1; one end of the first capacitor C1 is coupled to the drain of the first switching transistor M1, and the other end of the first capacitor C1 is grounded.

Continuing with reference to FIG. 3, the low-side power stage circuit 350 includes: a third resistor R3, a second switching transistor M2, a fourth resistor R2, and a second capacitor C2, wherein one end of the third resistor R3 is coupled to the gate of the second switching transistor M2, and the other end of the third resistor R3 is grounded; the gate of the second switching transistor M2 is coupled to the outputs of the microcontroller algorithm control circuit 320 and the watchdog fault-free signal circuit 330, the source of the second switching transistor M2 is grounded, and the drain of the second switching transistor M2 is coupled to a second end of the collision notification resistor Rn; one end of the fourth resistor R4 is grounded, and the other end of the fourth resistor R4 is coupled to the drain of the second switching transistor M2; one end of the second capacitor C2 is coupled to the drain of the second switching transistor M2, and the other end of the second capacitor C2 is grounded.

In the collision notification circuit of FIG. 3, the collision event safety signal circuit 315 includes: a fifth resistor R5, a sixth resistor R6, a third switching transistor M3, a seventh resistor R7, a first transistor Q1, an eighth resistor R8, a ninth resistor R9, a tenth resistor R10, and a second transistor Q2, wherein one end of the fifth resistor R5 is coupled to the gate of the third switching transistor M3, and the other end of the fifth resistor R5 is grounded; one end of the sixth resistor R6 is coupled to the second power supply V2, and the other end of the sixth resistor R6 is coupled to the drain of the third switching transistor M3; the gate of the third switching transistor M3 is coupled to a collision trigger signal 312 (e.g., from an application-specific integrated circuit chip ASIC), and the source of the third switching transistor M3 is grounded; one end of the seventh resistor R7 is coupled to the second power supply V2, and the other end of the seventh resistor R7 is coupled to the emitter of the first transistor Q1; the base of the first transistor Q1 is coupled to the drain of the third switching transistor M3, the collector of the first transistor Q1 is coupled to one end of the eighth resistor R8, and the other end of the eighth resistor R8 is grounded; one end of the ninth resistor R9 is coupled to the collector of the first transistor Q1, and the other end of the ninth resistor R9 is coupled to the base of the second transistor Q2; one end of the tenth resistor R10 is coupled to the gate of the first switching transistor M1 in the high-side power stage circuit 340 to provide a first drive signal, the other end of the tenth resistor R10 is coupled to the collector of the second transistor Q2, and the emitter of the second transistor Q2 is grounded.

For example, when a collision event occurs (the collision trigger signal 312 transitions from a low-level signal to a high-level signal), the collision event safety signal circuit 315 will output a low level (Note: when no collision event occurs, the collision event safety signal circuit 315 is in a high-impedance/off state), thereby turning on the subsequent high-side power stage circuit 340.

Further referring to FIG. 3, the microcontroller algorithm control circuit 320 includes an eleventh resistor R11, and the watchdog fault-free signal circuit 330 includes a twelfth resistor R12 and a fourth switching transistor M4. One end of the eleventh resistor R11 is coupled to a control signal 322 from the microcontroller, and the other end of the eleventh resistor R11 is coupled to the gate of the second switching transistor M2 in the low-side power stage circuit 350. One end of the twelfth resistor R12 is coupled to the gate of the fourth switching transistor M4, and the other end of the twelfth resistor R12 is grounded. The drain of the fourth switching transistor M4 is coupled to the gate of the second switching transistor M2 in the low-side power stage circuit 350, the gate of the fourth switching transistor M4 is coupled to a monitoring signal 332 from a watchdog circuit, and the source of the fourth switching transistor M4 is grounded.

For example, the microcontroller may perform calculations based on input sensor data (e.g., acceleration data). When a collision event occurs, the control signal 322 from the microcontroller will be set to a high level. Furthermore, for example, when the microcontroller is fault-free, the monitoring signal 332 will be set to a low level; otherwise, i.e., when the microcontroller malfunctions, the monitoring signal 332 will be set to a high level.

In the embodiment of FIG. 3, the first switching transistor M1 is a PMOS transistor, and the second switching transistor M2 is an NMOS transistor. That is to say, the first switching transistor M1 is turned on by a low-level signal, while the second switching transistor M2 is turned on by a high-level signal.

Assuming the first power supply in FIG. 3 is 5V and the second power supply is 3V, when no collision event occurs, since the first switching transistor M1 in the high-side power stage circuit 340 and the second switching transistor M2 in the low-side power stage circuit 350 are in an off state, the 5V power supply will flow to ground via the second resistor R2 (e.g., 2.5 kΩ, located in the high-side power stage circuit 340), Rn (the collision notification resistor, e.g., 7.5 kΩ), and the fourth resistor R4 (e.g., 2.5 kΩ, located in the low-side power stage circuit 350). That is, the voltage across the collision notification resistor Rn can be calculated as 5V/12.5 kΩ * 7.5 kΩ=3V. If a collision event occurs, at least one of the first switching transistor M1 in the high-side power stage circuit 340 and the second switching transistor M2 in the low-side power stage circuit 350 will be in a conductive state. The voltage (voltage division) across the collision notification resistor Rn will increase, and when both the first switching transistor M1 and the second switching transistor M2 are simultaneously conductive, the voltage across the collision notification resistor Rn will be 5V (i.e., the 5V power supply is directly applied across Rn). Therefore, by comparing the voltage change (i.e., the differential voltage) across the collision notification resistor Rn, it is possible to determine whether a collision has occurred.

It should be noted that in the collision notification circuit of FIG. 3 described above, only the load 360 is shown as the collision notification resistor Rn. However, in practical use, there may be multiple external ECUs simultaneously detecting the voltage change across the collision notification resistor Rn to determine whether a collision has occurred. That is to say, although not shown in FIG. 3, the collision notification resistor Rn may also have resistors or other circuit elements from multiple other ECUs connected in parallel across its terminals. The collision notification circuit of FIG. 3 has been designed to provide sufficient drive current to drive these multiple external ECUs.

In one or more embodiments, the potential fault modes of the collision notification circuit include: battery short circuit, ground short circuit, cross-coupling, resistance change of the collision notification resistor Rn, open/short circuit of the high-side power stage circuit, and open/short circuit of the low-side power stage circuit. These potential fault modes can also be characterized by the voltage change across the collision notification resistor Rn. For example, when the voltage across the collision notification resistor Rn is greater than a preset threshold related to the first power supply (e.g., 6~7V), it may be determined that a battery short circuit condition possibly exists. As another example, if the voltage across the collision notification resistor Rn remains constant regardless of whether the first switching transistor M1 is conductive or off, there may be a short circuit condition in the high-side power stage circuit 340. As yet another example, if the voltage across the collision notification resistor Rn remains constant regardless of whether the second switching transistor M2 is conductive or off, there may be a short circuit condition in the low-side power stage circuit 350.

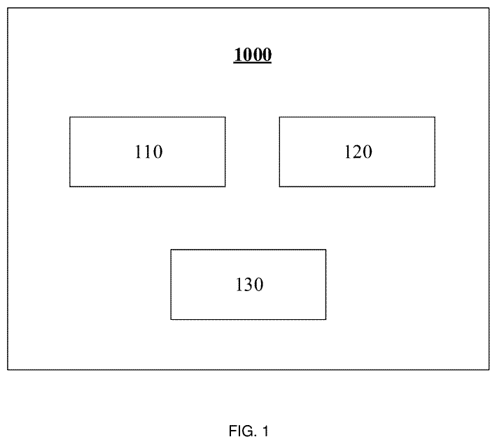

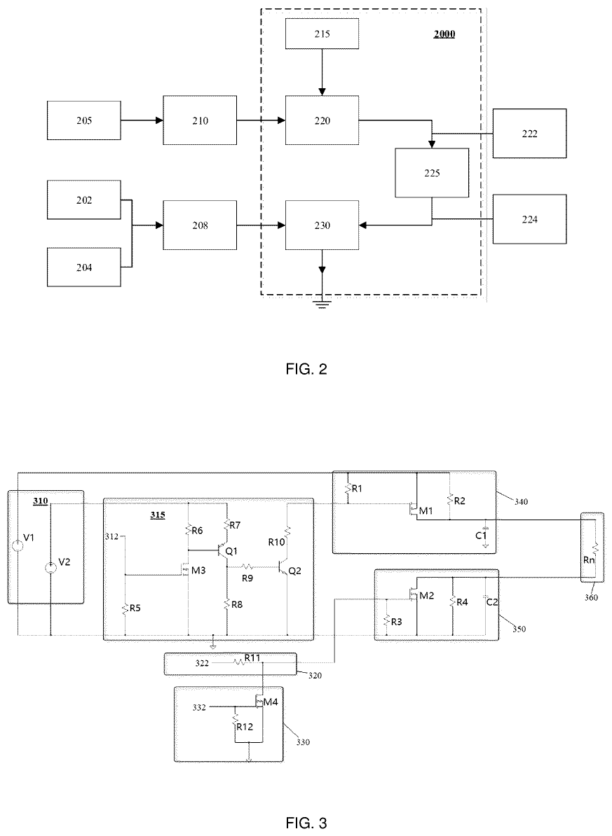

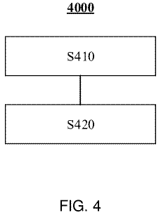

Turning to FIG. 4, it illustrates a schematic flowchart of a control method 4000 using a collision notification circuit according to an embodiment of the present application. As shown in FIG. 4, the method 4000 includes the following steps:
In step S410, confirming the occurrence of a collision event by monitoring voltage changes across the collision notification resistor in the collision notification circuit; and
In step S420, cutting off the power supply or performing other safety protection measures after confirming the collision event.

In one or more embodiments, the control method 4000 provided by the present application is executed by an Electronic Control Unit (ECU). Those skilled in the art will readily understand that the control method 4000 provided by the above one or more embodiments of the present application can be implemented by a computer program. For example, the computer program is contained in a computer program product. When the computer program is executed by a processor, it implements the control method 4000 of one or more embodiments of the present application. As another example, when a computer-readable storage medium (e.g., a USB flash drive) storing the computer program is connected to a computer, running the computer program executes the control method 4000 of one or more embodiments of the present application.

In summary, the collision notification circuit according to the embodiments of the present application provides an efficient, reliable, and cost-effective safety protection measure. For example, other electronic control units (ECUs) can be configured to determine whether a collision event has occurred by monitoring voltage changes across the collision notification resistor, thereby timely switching related power supplies or performing other protective measures to protect the safety of the driver and passengers. Additionally, the collision notification circuit is also capable of detecting various potential fault modes, such as open circuits, short circuits to the battery, short circuits to ground, and cross-coupling, which helps improve the overall safety and reliability of new energy vehicles.

Compared to the method of using an airbag system to cut off the high-voltage battery, the collision notification circuit according to the embodiments of the present application is less costly and easier to repair. Furthermore, in one embodiment, the collision notification circuit uses a differential voltage to detect a collision event. This differential voltage can last for hundreds of milliseconds (e.g., by setting a suitably large capacitor in the circuit), providing higher robustness. This means that even under extreme conditions, such as brief signal loss, the collision notification circuit can reliably notify of a collision event.

The above examples primarily illustrate the collision notification circuit solution of the embodiments of the present application. Although only some of the examples of the present application have been described, it should be understood by those with ordinary skill in the art that the present application may be implemented in various other forms without departing from its spirit and scope. Therefore, the examples and embodiments presented are illustrative rather than limiting, and the present application may encompass various modifications and replacements without departing from the spirit and scope defined by the various patent claims.

What is claimed is:

1. A collision notification circuit, comprising:
a collision notification resistor, wherein a voltage change across the collision notification resistor is used to indicate the occurrence of a collision event and potential fault modes of the collision notification circuit;
a high-side power stage circuit coupled between a first power supply and the collision notification resistor and comprising a first switching transistor, wherein the first switching transistor is controlled by a first drive signal related to the collision event; and
a low-side power stage circuit coupled between the collision notification resistor and ground and comprising a second switching transistor, wherein the second switching transistor is controlled by a second drive signal related to the collision event, wherein the first drive signal and the second drive signal are independent of each other.

2. The collision notification circuit according to claim 1, wherein under normal conditions, the first switching transistor and the second switching transistor are in an off state, and in the event of a collision, the first switching transistor and the second switching transistor remain in a conductive state under the control of the first drive signal and the second drive signal, respectively.

3. The collision notification circuit according to claim 1, further comprising:
a collision event safety signal circuit configured to receive a collision trigger signal from an application-specific integrated circuit and adaptively output the first drive signal to turn on the first switching transistor.

4. The collision notification circuit according to claim 1, further comprising:
a microcontroller algorithm control circuit configured to evaluate a collision event based on sensor input data using a collision detection algorithm in a microcontroller; and
a watchdog fault-free signal circuit configured to indicate a monitoring result for the microcontroller,
wherein the microcontroller algorithm control circuit and the watchdog fault-free signal circuit jointly provide the second drive signal, and output the second drive signal to turn on the second switching transistor when the microcontroller algorithm control circuit evaluates that a collision event exists and the watchdog fault-free signal circuit indicates that the microcontroller is fault-free.

5. The collision notification circuit according to claim 1, wherein the high-side power stage circuit comprises: a first resistor, a first switching transistor, a second resistor, and a first capacitor, wherein one end of the first resistor is coupled to the first power supply, and the other end of the first resistor is coupled to the gate of the first switching transistor; the gate of the first switching transistor is coupled to the first drive signal, the source of the first switching transistor is coupled to the first power supply, and the drain of the first switching transistor is coupled to a first end of the collision notification resistor; one end of the second resistor is coupled to the first power supply, and the other end of the second resistor is coupled to the drain of the first switching transistor; one end of the first capacitor is coupled to the drain of the first switching transistor, and the other end of the first capacitor is grounded.

6. The collision notification circuit according to claim 5, wherein the low-side power stage circuit comprises: a third resistor, a second switching transistor, a fourth resistor, and a second capacitor, wherein one end of the third resistor is coupled to the gate of the second switching transistor, and the other end of the third resistor is grounded; the gate of the second switching transistor is coupled to the second drive signal, the source of the second switching transistor is grounded, and the drain of the second switching transistor is coupled to a second end of the collision notification resistor; one end of the fourth resistor is grounded, and the other end of the fourth resistor is coupled to the drain of the second switching transistor; one end of the second capacitor is coupled to the drain of the second switching transistor, and the other end of the second capacitor is grounded.

7. The collision notification circuit according to claim 6, wherein the first switching transistor is a PMOS transistor, and the second switching transistor is an NMOS transistor.

8. The collision notification circuit according to claim 3, wherein the collision event safety signal circuit comprises: a fifth resistor, a sixth resistor, a third switching transistor, a seventh resistor, a first transistor, an eighth resistor, a ninth resistor, a tenth resistor, and a second transistor, wherein one end of the fifth resistor is coupled to the gate of the third switching transistor, and the other end of the fifth resistor is grounded; one end of the sixth resistor is coupled to a second power supply, and the other end of the sixth resistor is coupled to the drain of the third switching transistor; the gate of the third switching transistor is coupled to the collision trigger signal, and the source of the third switching transistor is grounded; one end of the seventh resistor is coupled to the second power supply, and the other end of the seventh resistor is coupled to the emitter of the first transistor; the base of the first transistor is coupled to the drain of the third switching transistor, the collector of the first transistor is coupled to one end of the eighth resistor, and the other end of the eighth resistor is grounded; one end of the ninth resistor is coupled to the collector of the first transistor, and the other end of the ninth resistor is coupled to the base of the second transistor; one end of the tenth resistor is coupled to the high-side power stage circuit to provide the first drive signal, the other end of the tenth resistor is coupled to the collector of the second transistor, and the emitter of the second transistor is grounded.

9. The collision notification circuit according to claim 4, wherein the microcontroller algorithm control circuit comprises an eleventh resistor, and the watchdog fault-free signal circuit comprises a twelfth resistor and a fourth switching transistor, wherein one end of the eleventh resistor is coupled to a control signal from the microcontroller, and the other end of the eleventh resistor is coupled to the low-side power stage circuit; one end of the twelfth resistor is coupled to the gate of the fourth switching transistor, and the other end of the twelfth resistor is grounded; the drain of the fourth switching transistor is coupled to the low-side power stage circuit, the gate of the fourth switching transistor is coupled to a monitoring signal from a watchdog circuit, and the source of the fourth switching transistor is grounded.

10. The collision notification circuit according to claim 1, wherein the potential fault modes of the collision notification circuit comprise: battery short circuit, ground short circuit, cross-coupling, resistance change of the collision notification resistor, open/short circuit of the high-side power stage circuit, and open/short circuit of the low-side power stage circuit.

11. A control method using the collision notification circuit according to claim 8, comprising:
confirming the occurrence of a collision event by monitoring voltage changes across the collision notification resistor in the collision notification circuit; and
cutting off the power supply or performing other safety protection measures after confirming the collision event.

12. An electronic control unit, wherein the electronic control unit is configured to execute the control method according to claim 11.
